(19) United States
(12) Patent Application Publication
(10) Pub. No.: US 2018/0335163 A1
(43) Pub. Date: Nov. 22, 2018

(54) High Security Flush Plug Assembly

(71) Applicant: David Stadler, Lathrup Village, MI (US)

(72) Inventor: David Stadler, Lathrup Village, MI (US)

(21) Appl. No.: 15/983,981

(22) Filed: May 18, 2018

Related U.S. Application Data
(60) Provisional application No. 62/508,019, filed on May 18, 2017.

(51) Int. Cl. F16K 35/06

(52) U.S. Cl. CPC F16K 35/06

(57) ABSTRACT

A high security flush plug assembly includes a flush plug body threaded into a flush plug bore in a curb box flange, with a security bolt extending down through a hole in the flush plug body. The security bolt is received in a locking mechanism mounted thereto and extending below the flush plug body which when operated acts to engage the inside of the stand pipe to prevent any rotation of the flush plug body, preventing its removal until the locking mechanism is operated to release the engagement with the stand pipe.

### CROSS REFERENCE TO RELATED APPLICATION

This application claims the benefit of U.S. provisional patent application No. 62/508,019 filed on May 18, 2017.

### BACKGROUND OF THE INVENTION

This invention concerns shut off valves such as are usually associated with utility supply lines to a customer.

A shut off valve is normally provided in order to be able to shut off service for maintenance or to end service for nonpaying customers which is only accessible through a hole in a curb box. A flush plug threaded into the hole must be removed in order to allow operation of the shut off valve by means of a long tool inserted through the hole after the flush plug is removed. The tool is long enough to extend down to the shutoff valve at the bottom of the stand pipe.

In order to provide access to the shut off valve only to authorized personnel, the threaded flush plug is typically provided with a pentagonal shaped socket wrenching feature on the top of the flush plug which requires a pentagonal socket to unscrew, since standard hex socket wrenches cannot engage such a pentagonal feature. However, this approach has become only minimally effective, as pentagonal socket wrenches are now easily obtainable by anyone as from various supply houses such as Graingers.

In an effort to improve security, special bolt heads have now been devised which typically are shaped uniquely for each utility and matching wrench tools are sold only to the utility company personnel, substantially reducing the possibility that an unauthorized person can obtain such a tool to thereby substantially improve the ability to prevent unauthorized removal of the plug to gain access to the shut off valve.

A security cover arrangement for a curb box is described in U.S. Pat. No. 9,790,714 granted to the present invention, relying on a specially shaped bolt head to prevent unauthorized removal of the cover.

That arrangement is designed to work only with a particular configuration of a curb box having an internal flange formed with a threaded hole receiving a retention bolt.

In the case of a curb box using a threaded flush plug installed in a threaded bore in the flange to block access via the threaded bore in the flange, even if the high security unique wrenching feature is used, the flush plug which is threaded into the flange bore may be unscrewed to be removed as with a spanner tool engaging holes drilled in the flush plug, and thereby allow unauthorized access to the shut off valve.

Accordingly, it is an object of the present invention to provide a flush plug assembly which prevents unscrewing of a flush plug body.

It is another object to provide a flush plug assembly which simplifies the installation and removal of the flush plug assembly by authorized personnel.

### SUMMARY OF THE INVENTION

The above objects and other objects of the present invention which will be understood by those skilled in the art are achieved by a flush plug assembly having a flush plug body able to be threaded into the conventional threaded bore formed in the curb box flange and seated on an upper end of a stand pipe also threaded up into the flange thread bore.

A security bolt having a head formed with the special drive features described above extends through an opening in a bottom wall of a flush plug body and received in a locking mechanism located below the flush plug body and to which it is connected.

The locking mechanism includes components moved to firmly engage the inside of a stand pipe by rotation of the security bolt. This engagement prevents rotation of the flush body as long as the lock mechanism engagement exists to thereby prevent removal of the flush plug body.

The locking mechanism preferably includes a pair of locking pieces which are arranged one above the other.

The security bolt further passes through an opening in each locking piece are initially spaced apart but which are drawn together by continued rotation of the security bolt and become engaged with each other. That engagement causes the two locking pieces to be shifted radially outward in opposite directions from each other and thereby forcibly engage the inner wall of a stand pipe threaded into the flange bore to lock the flush plug assembly to the stand pipe and thereby prevent rotation of the flush plug assembly and thereby prevent its removal.

The locking pieces are preferably configured as hollow cylinders which are positioned in approximate vertical alignment with each other. An upper locking piece has an angled lower end and a lower locking piece has an angled upper end. The angled ends are positioned to be parallel with each other with the thickest portions of each locking piece next to the thinnest portion of the opposite locking piece.

The security bolt is threaded into a drive nut located below the lower locking piece held in a cross slot in a bottom wall thereof to prevent rotation thereof so that upon rotation of the security bolt the drive nut forces the lower locking piece upwardly into engagement with the angled lower end of the upper locking piece. Further rotation of the security bolt causes the two locking pieces to each shift radially out in opposite directions by the camming action of the angled ends to firmly engage opposite sides of the inner surface of the stand pipe. The flush plug assembly thus becomes locked to the fixed stand pipe to prevent any rotation of the flush plug assembly and thus prevent its removal.

The upper locking piece is held in alignment with the lower locking piece so that the angled ends are maintained parallel with each other by vertical pins held by the flush plug body and received in a cross slot formed in the upper end wall of the upper locking piece. The pins are also connect the upper locking piece to the flush plug body so that when engaged with the inside of the stand pipe, the flush plug body cannot be rotated.

The two locking pieces are urged apart by an interposed coil spring and are moved together by the action of the drive nut when the security bolt is turned.

The flush plug assembly can be removed by reverse rotation of the security bolt which causes the drive nut to move down into engagement with a lock nut threaded to the lower end of the security bolt preventing any relative motion of the parts of the flush plug assembly. Rotation of the security bolt thus causes unthreading of the plug body from flange bore enabling the flush plug assembly to be removed and thereby allowing access to the shut off valve with a tool inserted through the flange bore and down to the bottom of the stand pipe to the shut off valve.

### DESCRIPTION OF THE DRAWINGS

FIG. 1 is a perspective view of a conventional curb box flange recessed into a fragmentary section of pavement with a bore in the curb box flange receiving the flush plug assembly according to the present invention.

FIG. 2 is an exploded perspective view of the components of the flush plug assembly shown in FIG. 1.

FIG. 3 is a pictorial view of the flush plug assembly shown in FIG. 1.

FIG. 4A is a top view of an upper locking piece included in the flush plug assembly shown in FIG. 3 with the two centerlines of an extended bore formed therein indicated.

FIG. 4B is a view from the bottom of the upper locking piece shown in FIG. 4A.

FIG. 5 is an enlarged longitudinal sectional view of the flush plug assembly shown in FIG. 3 installed in a curb box and stand pipe with the flush plug assembly in a released state and rotated ninety degrees, with a fragmentary part of an installation/removal wrenching tool shown in broken lines.

FIG. 6 is a view of the longitudinal section of shown in FIG. 5 with two locking pieces included in the locking mechanism brought into contact with each other.

FIG. 7 is a view of the longitudinal section shown in FIGS. 5 and 6, with the two locking pieces fully moved and radially in opposite directions to engage the flange plug assembly with the inside of the upper end of the stand pipe.

FIG. 8 is a view of the longitudinal section as shown in FIG. 7 with the installation wrenching tool removed and a cover installed as well as a locking pin inserted in the lock nut spaced below the drive nut.

FIG. 9 is a view of the longitudinal section shown in FIGS. 5-8 with the cover removed and the security bolt rotated in a direction to disengage the locking pieces from the stand pipe and flange plug body partially unthreaded from the flange bore.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

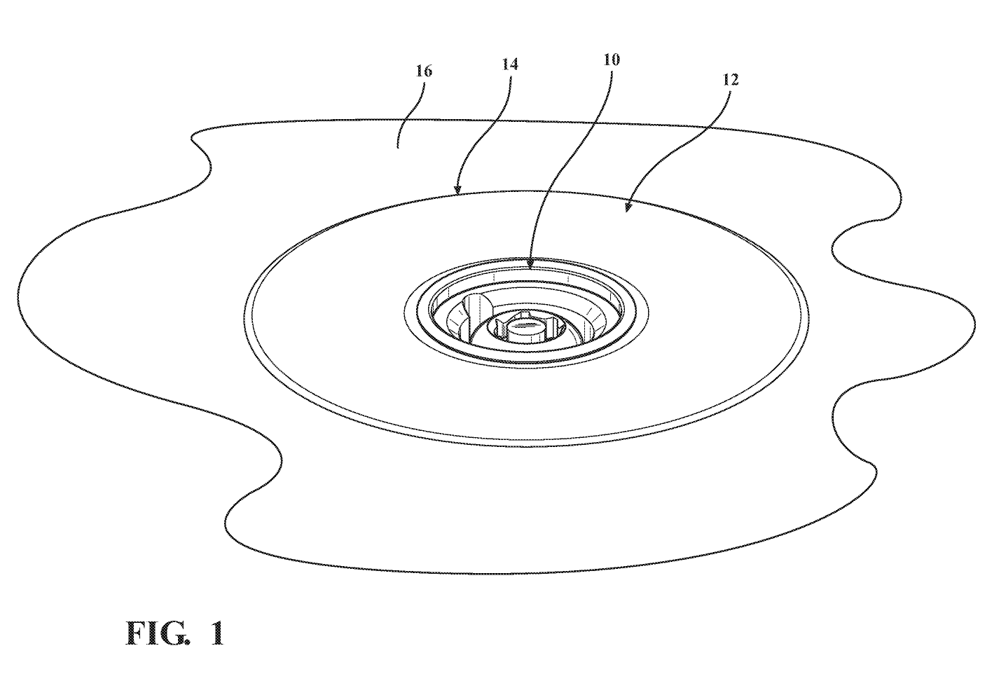

Referring to the drawings, FIG. 1 depicts a flush plug assembly 10 according to the invention installed in a threaded bore formed in a flange 12 of a curb box 14 recessed into paving 16.

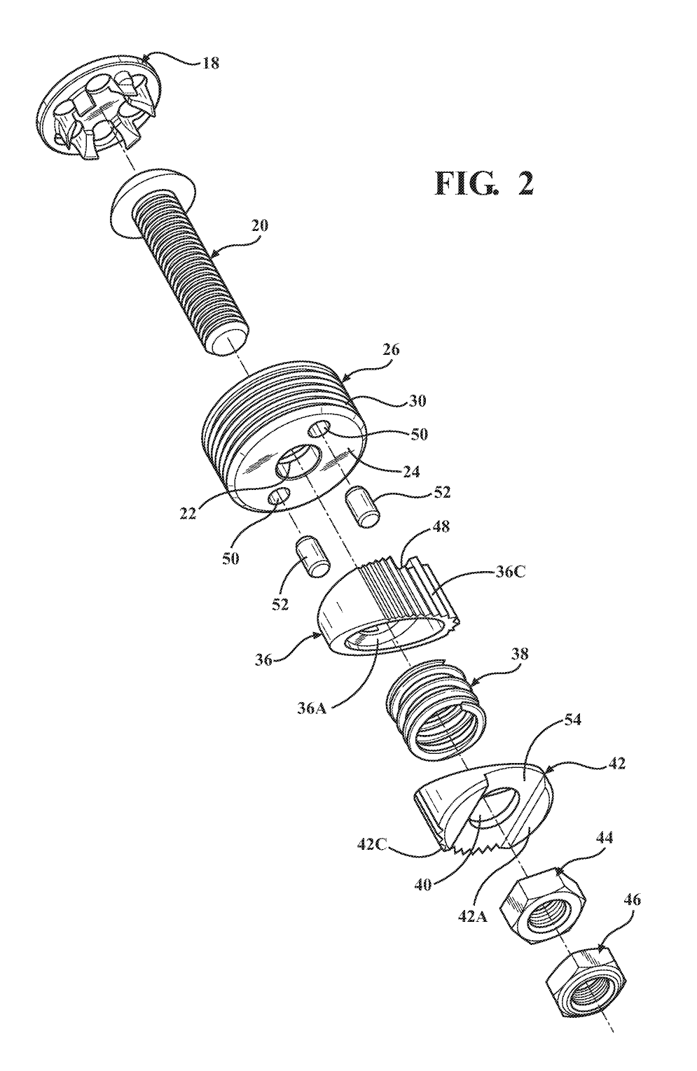

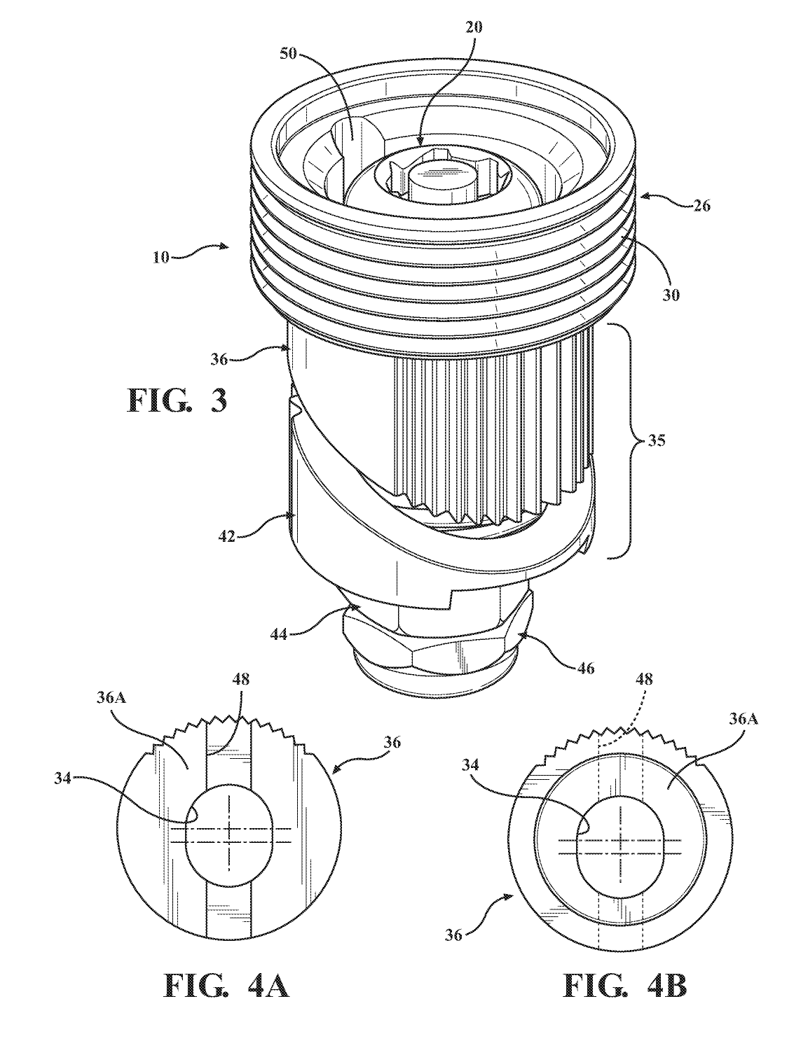

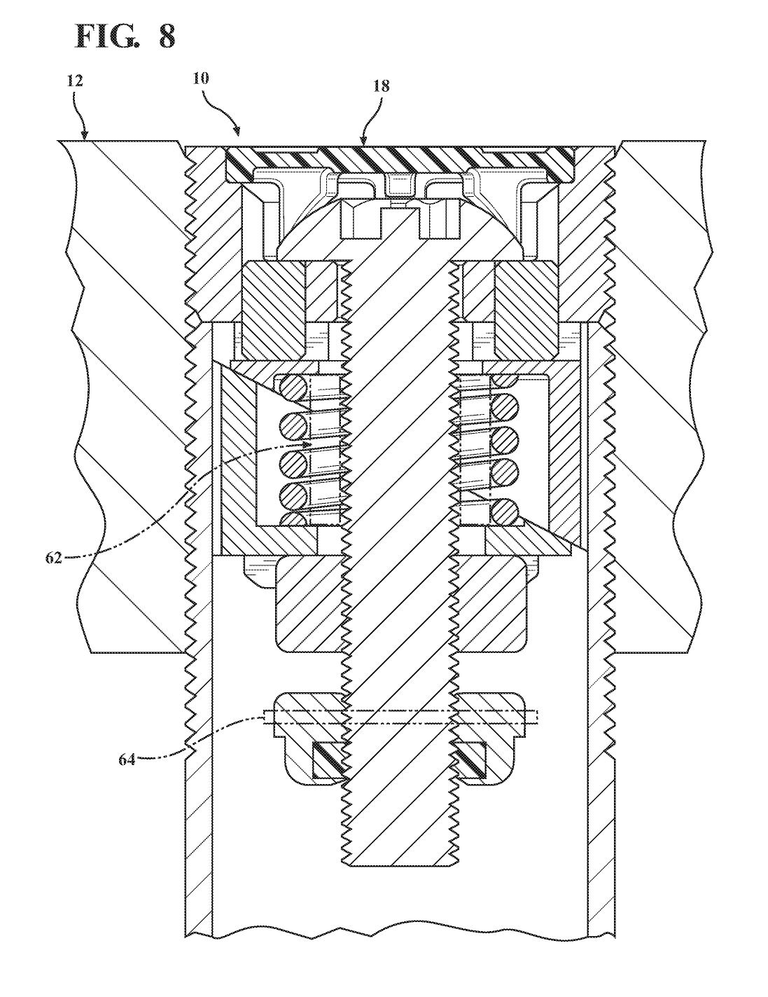

The components of the flush plug assembly 10 are shown in FIG. 2, which includes a cover 18 placed atop the flush plug assembly 10 after installation (FIG. 8).

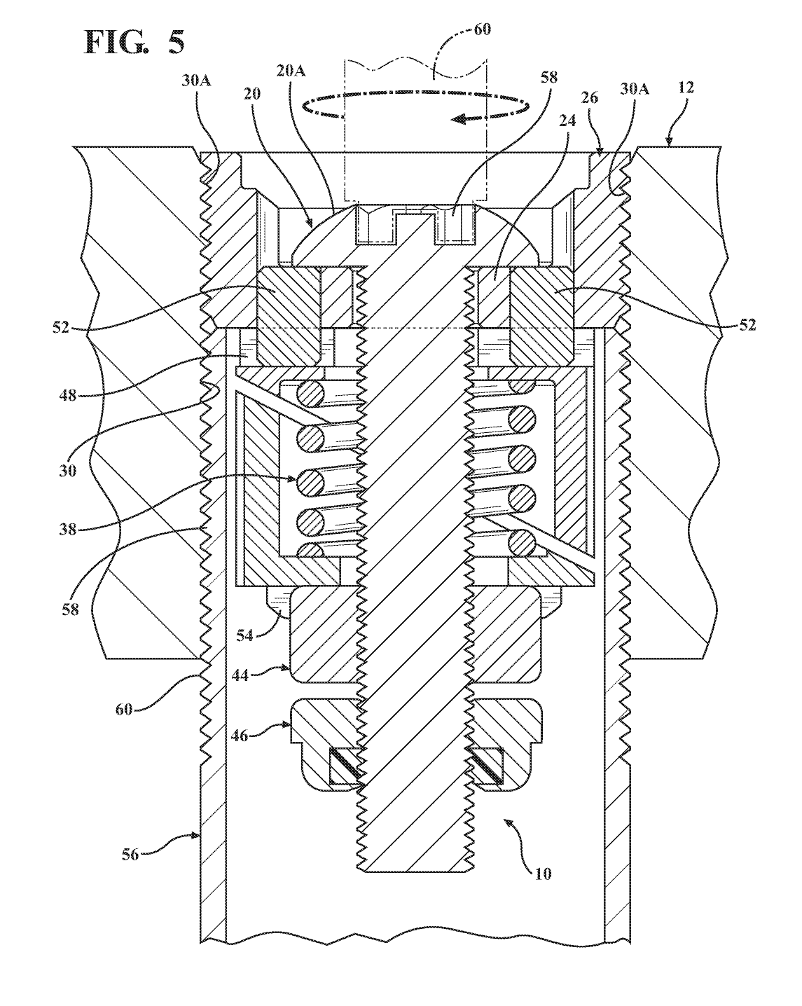

A stainless steel security bolt 20 passes through a hole 22 in a bottom wall 24 of a flush plug body 26 having an external thread 30 received into an internal thread 32A a bore in the flange 12 of the curb box 14 (FIG. 5).

In order to prevent the flange 12 from being rotated to be unthreaded from the flush plug body 26, the threads on the flush plug body are not cut to the upper end of the flush plug body 26. Thus, the flange cannot be completely unthreaded from the flush plug body.

The security bolt 20 is then received in a locking mechanism 35, passing through a slightly elongated hole 34 (FIGS. 4A, 4B) in an upper end wall 36A of an upper locking piece 36 which may be included in the locking mechanism, thence through a coil spring 38 and then through an elongated hole 40 in a lower end wall 42A of a lower locking piece 42 which may be included in the locking mechanism.

A drive nut 44 is threaded onto the lower end of the security bolt 20 protruding through the slightly elongated hole 40 and a lock nut 46 threaded thereon is spaced below the drive nut 44 a distance sufficient to allow operation of the locking mechanism.

The drive nut 44 and lock nut 46 may be abutted to cause the entire flush plug assembly 10 to be rotated in either direction in order to install or remove the flush plug assembly 10 as described below.

The upper and lower locking pieces 36 and 40 are generally shaped as hollow cylinders which each have at a 45° angle at one end thereof.

The upper locking piece 36 has a straight across end wall 36A which is at the top end thereof, (FIG. 4A, 4B) and the lower locking piece 42 has a straight end wall 42A at the bottom end thereof.

The 45° angle surfaces 36B, 42B are maintained in a position so that they are parallel to each other.

The upper locking piece 36 has a cross slot 48 aligned with the long axis of the elongated hole 34. The flush plug body 26 has a pair of spaced apart holes 50 into which a pair of pins 52 are inserted to project downward into the cross slot 48. This arrangement maintaining the proper orientation of the upper locking piece 36 and also positively connects the locking mechanism 35 to the flush plug body 26 so that the flush plug body 26 cannot turn if the locking mechanism is engaged.

The bottom locking piece 42 has a wider cross slot 54 recessed into the end wall 42A into which is received the drive nut 44 with opposite sides thereof confined by the slot sides to prevent rotation of the drive nut 44 relative the lower locking piece 42. The cross slot 54 is aligned with the long axis of the elongated hole 40 to properly maintain the proper orientation of the lower locking piece 42 as seen.

Referring again to FIG. 5, the flush plug assembly 10 is received in an upper section 32A of the internally threaded bore 32 in the flange 12. A stand pipe 56 has its upper end 58 threaded into the bottom of the bore 32. The pipe thread 60 is preferably tapered slightly as per conventional practice and is fully advanced to where the bottom of the upper section 30A is to be seated. Thus, when installed, the flush plug body 26 is seated against the upper end 58 of the stand pipe 56.

The head 20A of the security bolt 20 is formed with custom drive features 58 as described above and in U.S. Pat. No. 9,790,714, incorporated by reference herein, to only be able to be engaged with a corresponding custom tool 60, in the known manner.

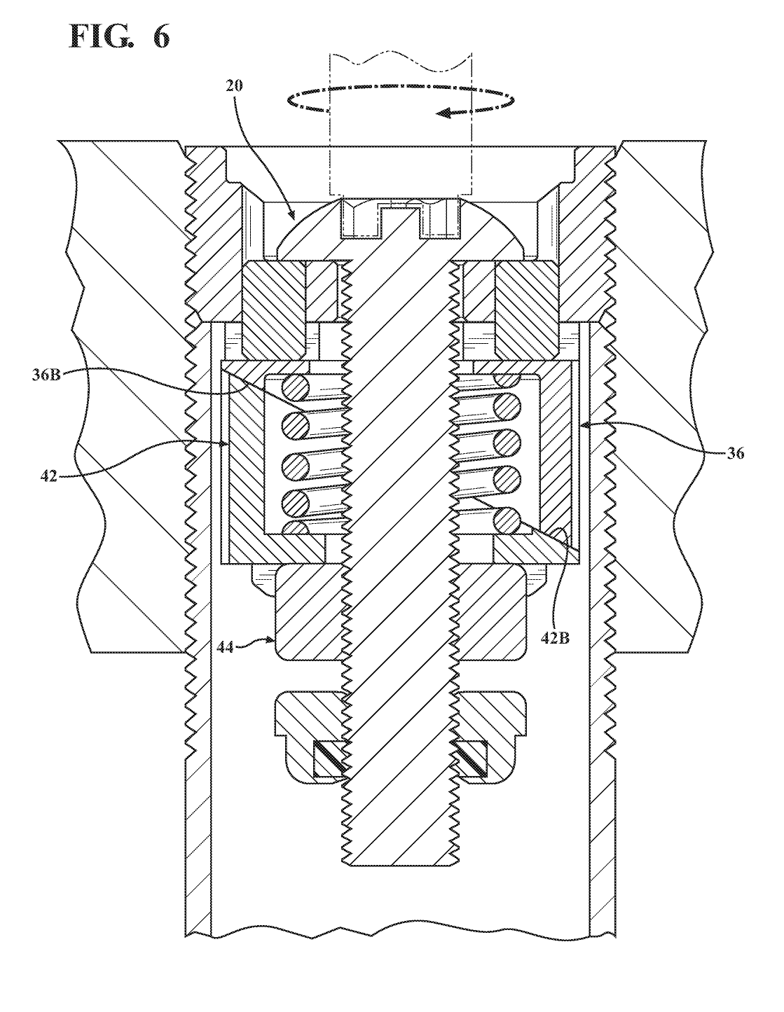

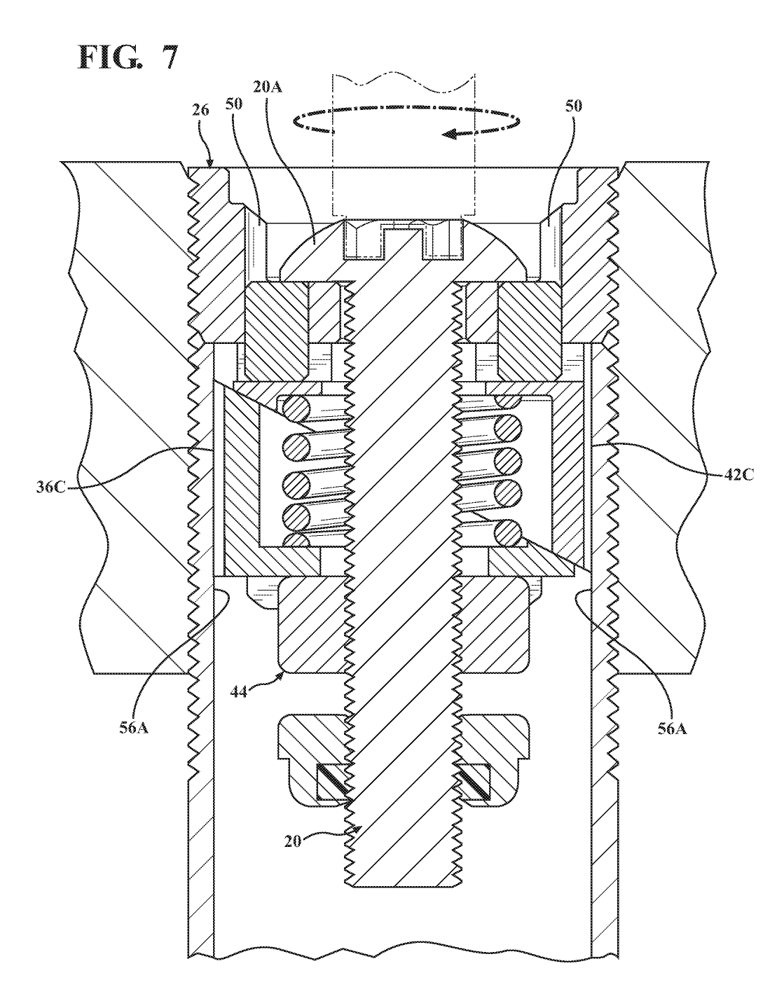

When the security screw 20 is rotated to the right, the confined drive nut 44 moves up the lower locking pieces 42 to bring the angled ends 36B, 42B of the locking pieces 36, 42 into abutment as seen in FIG. 6, slightly compressing the spring 38.

Continued rotation of the security bolt 20 causes the engaged angled ends 36B, 42B of the locking pieces 36, 42 to cam each other to shift the locking pieces 36, 42 radially outward in opposite direction. This movements brings the outer ribbed surfaces 36C, 42C into tight engagement with the opposite inner surface 56A of the stand pipe 56 to positively prevent any rotation of the flush plug body 26 and thereby prevent removal of the flush plug assembly 10 including the flush plug body 26.

As seen in FIG. 8, installing the cover 18 completes the installation.

A porous Teflon sleeve 62 (FIG. 8) containing lubricant can also be installed around the security bolt 20, which is compressed when the locking mechanism 35 is operated which will lubricate the threads to extend the life of the flush plug assembly 10.

The flush plug assembly 10 can be readily removed by reverse rotation of the security bolt 20.

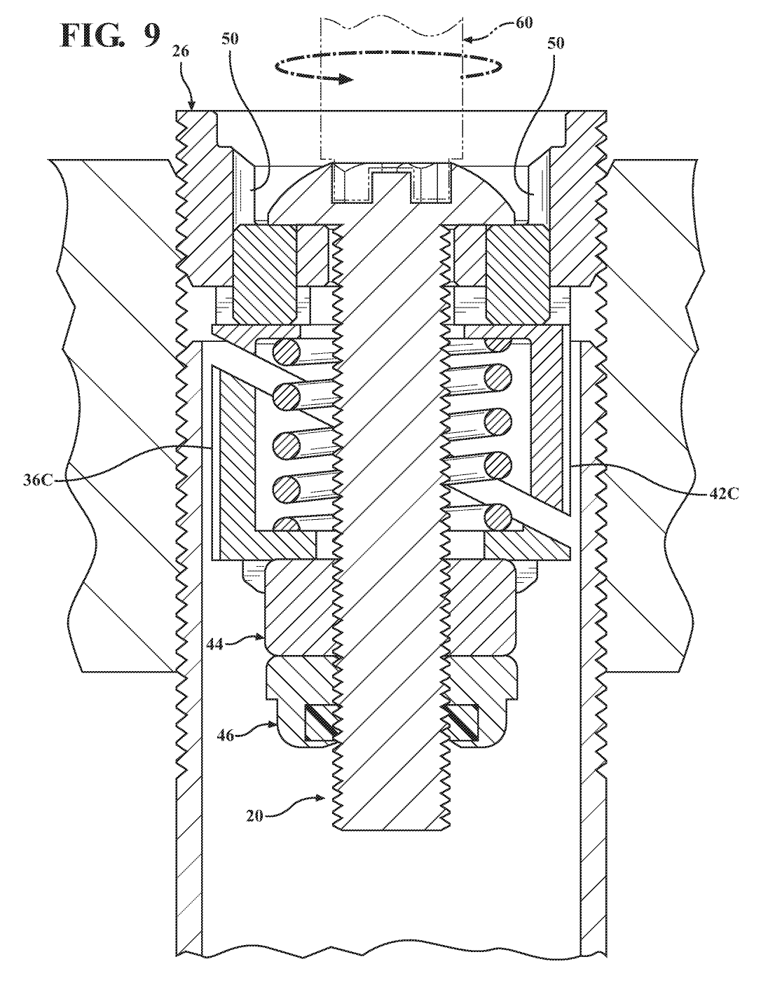

This first moves the upper and lower locking pieces 36, 42 to be disengaged and separated, and subsequently causes the drive nut 44 to descend on the bolt 20 to be brought into engagement with the lock nut 46 (FIG. 9). This engagement locks the bolt 20 to the drive nut 44 and prevents any individual movement of the components of the flush plug assembly 10 so the rotation of the security screw rotates the entire flush plug assembly 10. This causes the flush plug body 26 to be unscrewed as shown partially done in FIG. 9 to remove the entire assembly from the flange 14.

A custom scanner tool (not shown) may be used to engage the holes 50 if greater leverage is required to loosen the flush plug body 26 than can be exerted by rotating the security bolt 20.

1. A flush plug assembly for blocking access to a stand pipe through a threaded bore in a flange of a curb box, said stand pipe threaded into a lower portion of said flange threaded bore, said flush plug assembly including a flush plug body adapted to be threaded into an upper portion of said flange threaded bore;
a security bolt extending down through an opening in said flush plug body;
said security bolt received in a locking mechanism located below said flush plug and connected thereto, said locking mechanism including an arrangement for engaging an inside surface of said stand pipe so as to thereby prevent rotation of said flush plug body so as to prevent removal from said flange bore.

2. The flush plug assembly according to claim 1 wherein said locking mechanism includes a pair of locking pieces which are forced radially outward in opposite directions by rotation of said security bolt to engage said stand pipe on opposite sides.

3. The flush plug assembly according to claim 2 wherein pair of locking pieces include an upper and lower locking pieces which each have an angled end facing each other which are brought into engagement by said rotation of said security bolt which causes each of said upper and lower locking pieces to be moved radially out in opposite directions from each other with continued rotation of said security bolt.

4. The flush plug assembly according to claim 3 wherein a compression spring is interposed between said upper and lower locking pieces to urge said upper and lower locking pieces apart from each other overcome by said drive element when said security bolt is rotated in one direction.

5. The flush plug assembly according to claim 3 further including a drive element comprising a nut on said security bolt is engaged with one of said locking pieces so as to move said upper and lower locking pieces vertically toward each and wherein said angled ends are engaged with each other by continued rotation of said security bolt to be moved radially outward in opposite directions to be brought into engagement with said stand pipe.

6. A flush plug assembly for blocking a threaded bore in a curb box flange said threaded bore receiving a threaded stand pipe extending down to a utility shut off valve comprising:
a threaded flush plug body able to be threaded into a top of said flange threaded bore, flush plug body having an opening in a bottom wall thereof;
a hollow cylindrical upper locking piece having an angled lower end,
a hollow cylindrical lower locking piece having an angled upper end facing said angled lower end of said upper locking piece, said upper and lower locking pieces oriented so that said angled locking piece ends are a parallel to each other;
a security bolt successively passing through said opening in said threaded plug bottom wall, an opening in an upper end wall of said upper locking piece and an opening in a bottom wall of said bottom locking piece;
a cross slot recessed down into said upper end wall of said upper locking piece and pins extending down from said bottom wall of said threaded plug into said cross slot of said upper locking piece of said upper locking piece; and
a cross slot recessed up into said bottom wall of said lower locking piece, with a drive nut threaded onto said security bolt disposed in said cross slot of said bottom locking piece so as to maintain said orientation of said lower locking piece relative said lower locking piece;
a lock nut threaded onto said security bolt at a location normally spaced below said drive nut;
a coil spring on said security bolt compressed between said top wall of said upper locking piece and said bottom wall of said bottom locking piece whereby continued rotation of said security bolt in one direction causes said drive nut to compress said upper and lower locking pieces together to engage said angled ends of said upper and lower cross pieces with each other and thereby force said locking pieces to move radially out in opposite directions, and engage an inner surface of said stand pipe to secure said flush plug assembly in said down pipe.
